(19) United States
(12) Patent Application Publication
(10) Pub. No.: US 2010/0299419 A1
(43) Pub. Date: Nov. 25, 2010

(54) SYSTEM AND METHOD FOR A SELF ORGANIZING NETWORK

(75) Inventors: RAJESH RAMANKUTTY, Nashua, NH (US); Rajeev Koodli, Sunnyvale, CA (US); Kuntal Chowdhury, Andover, MA (US); Kalidas Porika, Nashua, NH (US)

Correspondence Address: WILMERHALE/BOSTON, 60 STATE STREET, BOSTON, MA, 02109, US

(73) Assignee: Cisco Technology, Inc., San Jose, CA (US)

(21) Appl. No.: 12/781,436

(22) Filed: May 17, 2010

Related U.S. Application Data
(60) Provisional application No. 61/178,812, filed on May 15, 2009.

(51) Int. Cl. G06F 15/177

(52) U.S. Cl. 709/221

(57) ABSTRACT

Systems and methods are disclosed that provide self management of network devices in a communication network. These management abilities allow a network device to perform functions, for example, that improve resource distribution, allow for maintenance and upgrades, and provide session management and policy enforcement in a coherent and organized fashion. In a self organizing network (SON), some network devices can be configured to provide self-configuration and self-optimizing capabilities to provide the ability to automate certain operations and management functions and system management functions. The SON incorporates self-configuration, self-optimization, monitoring, and operation management to allow the network devices to be inserted into the network and operate with little to no human intervention.

### CROSS-REFERENCE TO RELATED APPLICATIONS

This application claims benefit under 35 U.S.C. §119(e) of U.S. Provisional Patent Application No.: 61/178,812, entitled “System and Method for a Self Organizing Network,” filed May 15, 2009, and is hereby incorporated by reference herein in its entirety.

### FIELD OF THE DISCLOSURE

This disclosure relates to the field of telecommunications, and more particularly, a system and method for providing a self organization in a communication network.

### BACKGROUND

Wireless networks are telecommunications networks that use radio waves to carry information from one node in the network to one or more receiving nodes in the network. Wired communication can also be used in portions of a wireless network, such as between cells or access points. Cellular telephony is characterized by the use of radio cells that provide radio coverage for a geographic area, with multiple cells arranged to provide contiguous radio coverage over a larger area.

The first generation of wireless telephone technology used analog mobile phones in which analog information signals were transmitted. As technology progressed a second generation (2G) of wireless service was introduced. In 2G systems, digital information signals were used to modulate a carrier. These 2G technologies used time division multiplexed access (TDMA) or code division multiple access (CDMA) technologies to distinguish multiple users. Such networks that were upgraded to handle higher-speed packet data in networks referred to as 2.5G and 3G networks. The 3rd Generation Partnership Project (3GPP) and the 3rd Generation Partnership Project 2 (3GPP2) respectively developed the GSM/UMTS/HSDPA and cdmaOne/CDMA2000 technologies. The next evolution is 4G technology, which is referred to as long term evolution-system architecture evolution (LTE-SAE) and uses orthogonal frequency division multiple access (OFDMA) technology.

Other wireless protocols have also developed including WiFi, an implementation of various IEEE 802.11 protocols, WiMAX, an implementation of IEEE 802.16, and HiperMAN, which is based on an ETSI alternative to IEEE 802.16.

Wireless communication technologies are used in connection with many applications, including, for example, satellite communications systems, portable digital assistants (PDAs), laptop computers, and mobile devices (e.g., cellular telephones, user equipment). One benefit that users of such applications can obtain is the ability to connect to a network (e.g., the Internet) as long as the user is within range of such a wireless communication technology.

### SUMMARY OF THE DISCLOSURE

Systems and methods are disclosed that provide self management of network devices in a communication network. These management abilities allow a network device to perform functions, for example, that improve resource distribution, allow for maintenance and upgrades, and provide session management and policy enforcement in a coherent and organized fashion. In a self organizing network (SON), some network devices can be configured to provide self-configuration and self-optimizing capabilities to provide the ability to automate certain operations and management functions and system management functions. The SON incorporates self-configuration, self-optimization, monitoring, and operation management to allow the network devices to be inserted into the network and operate with little to no human intervention.

In some embodiments, a method is disclosed that includes initiating at a network device, upon introduction to a self-organizing network, communication to acquire addressing information of the network device and a managing server for the self-organizing network, and to obtain configuration information from the management server to initialize the network device on the self-organizing network, performing a self-test at the network device to determine how to configure the network device on the self-organizing network and sending the self-test results to the management server to obtain additional configuration information that is based on the results of the self-test, announcing information from the network device to initiate exchange of information with other network devices and establish connections to provide service to user equipment sessions on the self-organizing network, monitoring capacity, resources, and user equipment session information on the network device and logging this information for use by the management server, and adjusting parameters relating to a plurality of user equipment sessions and determining whether to accept and how to modify existing user equipment sessions based on instructions received from the management server.

In other embodiments, a network device is disclosed that provides an interface configured to communicate with a server to obtain an IP address for the network device and to obtain an IP address for a management server, an interface configured to communicate with the management server to obtain software and configuration information to initialize the network device on a self-organizing network, an interface configured to communicate with other network devices in the self-organizing network to exchange information and establish connections to provide service to user equipment sessions on the self-organizing network, a self-test function configured to obtain operation and capability information regarding the network device, a self-configuration function that configures the network device for operation in the self-organizing network using the software and configuration information received from the management server, and the network device modifies its operation and configuration based upon instructions received from the management server, and a self-configuration monitoring function configured to monitor capacity, resources, and user equipment session information on the network device and logging this information for use by the management server.

In yet other embodiments, a method is disclosed that includes acquiring an IP address and a management server address from a dynamic host configuration protocol (DHCP) server, communicating from a network device with a management server to download software and configuration information to setup the network device, performing a self test of the network device to obtain result and measurement information regarding capabilities of the network device that are used to determine how to configure the network device for operation in the self organizing network, contacting other network devices to determine the other network devices capabilities and providing the other network devices information regarding the network device, monitoring resources and other information regarding the network device for communication to the management server, receiving instructions from the management server on the network device and modifying the configuration of the network device in accordance with the instructions.

### BRIEF DESCRIPTION OF THE DRAWINGS

FIG. 1 illustrates a network diagram in accordance with certain embodiments.

FIG. 2 illustrates communication between an MME pool, a SGW set, and an eNB cluster in accordance with certain embodiments.

FIG. 3 illustrates a network view of an evolved packet core SON in accordance with some embodiments.

FIG. 4 illustrates self configuration messaging in a self-organizing network in accordance with some embodiments.

FIG. 5 illustrates self-organizing network functions in accordance with certain embodiments.

FIG. 6 illustrates a message flow for the auto-configuration of a MME in accordance with some embodiments.

FIG. 7 illustrates a message flow for the auto-configuration of a SGW in accordance with some embodiments.

FIG. 8 illustrates network device reporting of information in accordance with certain embodiments.

FIG. 9 illustrates network device selection at a MME using a selection logic in accordance with some embodiments.

FIG. 10 illustrates another embodiment of a self-organizing network in accordance with some embodiments.

FIG. 11 illustrates a chassis in accordance with certain embodiments.

### DETAILED DESCRIPTION

Systems and methods are disclosed that provide self management of network devices in a communication network. In a self organizing network (SON), some network devices can be configured to implement self-configuration and self-optimizing capabilities to provide the ability to automate certain operations and management functions and system management functions. A self organizing network can minimize the lifecycle cost of running a network by eliminating manual configuration of equipment at the time of deployment, right through to dynamically optimizing radio network performance during operation. This can lead to operational efficiency and reduced operating costs for a network provider. The network devices can be a Gateway GPRS Support Node (GGSN), a Serving GPRS Support node (SGSN), a Mobility Management Entity (MME), a Serving Gateway (SGW), or a Packet Data Network Gateway (PGW), for example. The network devices can also be implemented on gateway platform such as a Cisco Systems' chassis platform that is further described below.

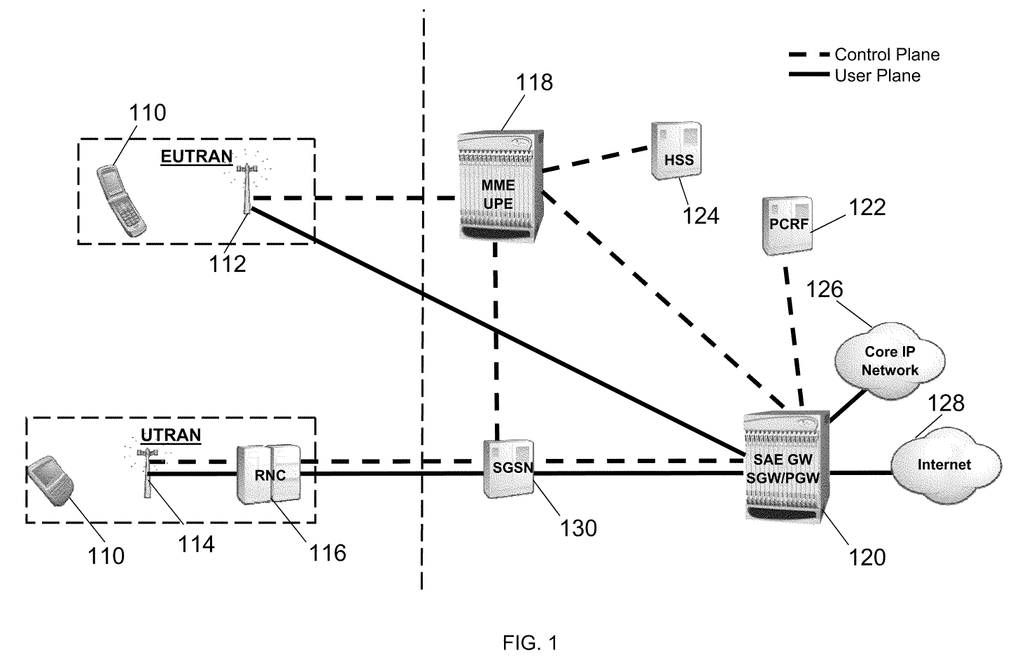

FIG. 1 illustrates an implementation in a long term evolution (LTE) network in accordance with certain embodiments. FIG. 1 illustrates both a universal mobile telecommunication system (UMTS) release 8 network and a LTE network. The network diagram of FIG. 1 includes user equipment (UE) 110, an evolved nodeB (eNB) 112, a nodeB 114, a radio network controller (RNC) 116, a mobility management entity (MME)/user plane entity (UPE) 118, a system architecture evolution gateway (SAE GW) 120, a policy and charging rules function (PCRF) 122, home subscriber server (HSS) 124, core IP network 126, internet 128, and Serving General packet radio service Support Node (SGSN) 130. The MME 118, SAE GW 120, and SGSN 130 can be implemented in a chassis as described below. The SAE GW 120 can include a serving gateway (SGW) as well as a packet data network gateway (P-GW). In some embodiments, the SGW and P-GW can be implemented on separate network devices. The main component of the SAE architecture is the Evolved Packet Core (EPC), also known as SAE Core. The EPC includes the MME, SGW and P-GW components.

MME 118 is a control-node for the LTE access network. The MME 118 is responsible for UE 110 tracking and paging procedures including retransmissions. MME 118 handles the bearer activation/deactivation process and is also responsible for choosing the SGW for a UE 110 at the initial attach and at the time of an intra-LTE handover. The MME 118 also authenticates the user by interacting with the HSS 124. The MME 118 also generates and allocates temporary identities to UEs and terminates Non-Access Stratum (NAS) signaling. The MME 118 checks the authorization of the UE 110 to camp on the service provider's Public Land Mobile Network (PLMN) and enforces UE roaming restrictions. The MME 118 is the termination point in the network for ciphering/integrity protection for NAS signaling and handles the security key management. Lawful interception of signaling is also supported by the MME 118. The MME also provides the control plane function for mobility between LTE and 2G/3G access networks with the S3 interface terminating at the MME 118 from the SGSN 130. The MME 118 also terminates the S6a interface towards the home HSS for roaming UEs.

The SGW routes and forwards user data packets, while also acting as the mobility anchor for the user plane during inter-eNB handovers and as the anchor for mobility between LTE and other 3GPP technologies (terminating S4 interface and relaying the traffic between 2G/3G systems and PDN GW). For idle state UEs, the SGW terminates the down link data path and triggers paging when down link data arrives for the UE 110. The SGW manages and stores UE contexts, e.g., parameters of the IP bearer service and network internal routing information. The SGW also performs replication of the user traffic in case of lawful interception. The PGW provides connectivity to the UE 110 to external packet data networks by being the point of exit and entry of traffic for the UE 110. A UE 110 may have simultaneous connectivity with more than one PGW for accessing multiple packet data networks. The P-GW performs policy enforcement, packet filtering for each user, charging support, lawful interception, and packet screening. The PGW also provides an anchor for mobility between 3GPP and non-3GPP technologies such as WiMAX and 3GPP2 (CDMA 1X and EvDO). The SGW or the PGW depending on the embodiment, can be used to provide deep packet inspection and provide advertising to the user on a per subscriber basis as described above on a chassis implementing a SGW or a PGW.

An evolved packet core self organizing network (SON) can be implemented by providing self configuration, self optimization, neighbor and peer discovery, and monitoring. In providing these capabilities, a number of functions can be involved in each of the network devices. The self configuration aspect allows network devices to obtain parameters that are used in device operation. For example, self configuration for a network device can include obtaining an address for the network device, determining an operations and management server location, obtaining transport parameters, obtaining updates to system software and hardware, setting up configuration files, and obtaining security contexts. The self optimization aspect allows network devices to use information to become more efficient in the network. This can include, for example, a network device changing its coverage area, modifying its capacity, modifying mobility parameters, and performing load balancing. The neighbor and peer discovery aspect can involve network devices learning about other network devices on the network. This discovery aspect can include, for example, eNodeB (eNB)-MME connectivity auto-configuration, MME-MME discovery and auto-configuration, and MME-SGW discovery and auto-configuration. Monitoring is another aspect of the self organizing network that involves tracking and recording events, statistics, and operating information. This monitoring can include load information, location information, protocol information, alarms, statistic information, failure information, hardware information, and sensor information.

The SON works by combining self-configuration, self-optimization, discovery, and monitoring capabilities and information from these aspects to allow the network to make decisions and react to problems that were previously manually implemented. For example, by using configuration information, neighbor and peer information, monitoring information with configuration and optimization capabilities, activities such as address configuration, pool configuration, coverage configuration, and load balancing can be managed by the network with minimal or no manual intervention. The capabilities allow the network to provide a better user experience and make the network more resilient against changing conditions. A self-organizing network has the ability to react to events faster than using one or more people to manually configure reactions to events. The self-organizing network provides dynamic configuration, monitoring, and response capabilities in otherwise static configurations.

For example, if there is a natural disaster that both damages equipment and overwhelms the system with callers, the self-organizing network can react in many ways. First, the self-organizing network can detect the changes in load (and monitor the situation). Second, it can detect if network devices go down in the network and the impact these failures have on the network. The self-organizing network can then use load balancing, changing of capacity and coverage of various network nodes to increase the availability of resources in a particular area by re-organizing the network and the network resources.

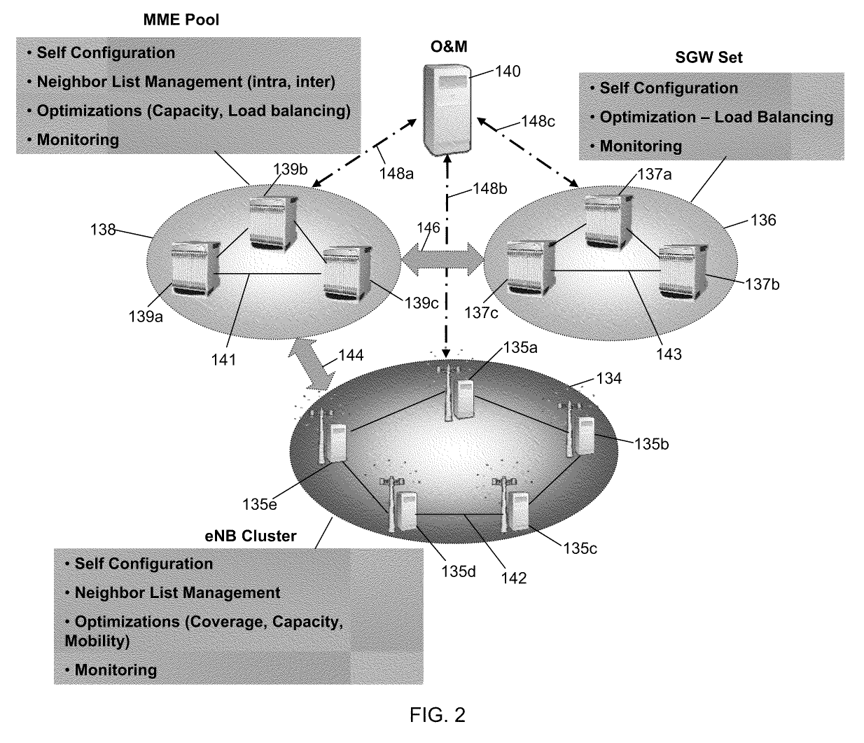

FIG. 2 illustrates communication between an MME pool, a SGW set, and an eNB cluster in accordance with certain embodiments. FIG. 2 includes an eNodeB (eNB) cluster 136 that includes a set of eNBs 135a-135e, SGW set 136 that includes a set of SGWs 137a-137c, an MME pool 138 that includes a set of MMEs 139a-139c, and a management server 140 that performs operations and management. The MMEs can communicate with one another using one or more communication links such as links 141, while eNBs can communicate using links 142, and SGWs can communicate using links 143. Communication between an MME pool, a SGW set, and an eNB cluster is implemented in a self-organizing network to provide information and feedback between the various network devices. For example, MME pool 138 can communicate with SGW set 136 using communication network 146 and with eNB cluster 134 using communication network 144. The MME pool, SGW set, and eNB cluster can be in communication with an operations and management server (“O&M” or “OAM”) server in conjunction with, or separately of, the communications between each other. These communications 148 can occur over the network or through one or more links.

As shown, the MME pool 138 can implement self-configuration, inter- and intra-neighbor list management, capacity and load balancing optimizations, and monitoring. The SGW set 136 can implement self-configuration, load balancing optimization, and monitoring. Additionally, the eNB cluster can implement self-configuration, neighbor list management, various optimizations (including coverage, capacity, and mobility), and monitoring. Other functionalities can also be implemented in the self-organizing network and each of the individual pools.

The self configuration implemented in the self-organizing network and on network devices in the self-organizing network can include many functions. It can involve, for example, exchange of capabilities with the other network devices, the assignment of configuration parameters, and assignment of a role to the a new network device that enters a MME pool, SGW set, or eNB cluster. Upon ‘drop in’ or entering a “cloud,” where the cloud can be any one of the networks of devices, a network device exchanges its capabilities with the other devices, learns its role in the network, and assigns configuration parameters to its interfaces with the network. Based on the network device's role and its assigned capabilities, the network device is provided a profile type. For example, a SGW capable of S5-PMIP (proxy mobile IP) and a SGW capable of S5-GTP (GPRS tunneling protocol) are assigned separate profile types, which the network device can share with its neighbors. The self-configuration can also involve assignment of an IP address to the network device based on the configuration of the network device and how the network device is to communicate with other network devices. This can be based on the profile type and other factors regarding the network device.

Once an IP address is assigned and the network device understands its role in the network, the network device can begin neighbor and peer discovery and auto-configuration with other network devices. The process of neighbor and peer discovery can be an active process or a passive process. In an active process, the network devices actively messages other network devices to obtain information and configure connections. In a passive process, the network device learns about its neighbors and peers through listening to communications. In either case, the network device can begin creating a database of information that is used to configure connections, to begin monitoring, and to prepare for dynamic optimization. The network device can learn various information about its neighbors such as the neighbor's profiles, address information, and capabilities.

A network device in a SON can also perform neighbor/peer discovery and auto-configuration to learn about other node or network devices in a group (e.g., MME pool). The learning involves learning about other network devices that are the same type of device and other network devices that are a different type of device. This allows the various network devices to communicate with each other in the self-organizing network. For example, a MME learns about its neighboring MMEs in order to manage which MMEs are handling which sessions and devices, and the MMEs learn about SGWs and eNBs in order to understand the capabilities of these devices so the MME can manage these devices. The eNBs also learn about the MMEs in order to connect to MMEs to establish transport sessions and to establish security associations, for example. Network devices also learn about each other. For example, an MME uses information about the MMEs that manage overlapping TAI lists in configuring itself and managing the TAI list, and so this information is stored locally in the MME.

Self-optimizations within the self-organizing network can include a number of functionalities. Self optimizations vary depending on the network device and the functionality of the network device and can include coverage, mobility, capacity, and load balancing optimizations in a communication network. The SON can also include monitoring that can be implemented to perform both self-checks and checks within groups of network devices. Also faults and failures are propagated among network devices to allow the network devices to react to such events. Coverage and mobility optimizations can occur in a radio access network (RAN), which includes devices such as eNBs. The coverage can include how eNBs are arranged to provide cell coverage over a geographic area. The eNBs can be configured to change the geographical area they are covering (e.g., their footprint). Mobility configurations influence how handoffs occur between device in the RAN. This can be configured to calibrate when a handoff occurs between eNB for user equipment.

Capacity and load balancing are applicable to network devices such as the MME and SGW. The capacity functionality includes one or more metrics of how much resources are being used on a network device. The capacity can be an indication of how much processing, memory, and/or networking bandwidth is being used on a particular device at a particular time. It can also be based on how many sessions or calls are being handled by a device. A session is a provision of service in the network device to communication from a user equipment. A user equipment can have more than one session in the network. A session can be, for example, the dedication of resources on a network device to handle the streaming of a movie for a user equipment or the handling of a voice call for a user equipment. For example, separate measurements of how much processing power is being used, how much memory is being used (which can include the number session running on a network device), and how much bandwidth is available for communication. In some embodiments, various monitor information is logged on the network devices and recorded into a storage device for later retrieval. The O&M server can retrieve this information and process the information to make decisions based on policies and then send control messaging to adjust parameters on the various network devices.

When optimizing various network devices, or groups of network devices, the self-organizing network propagates optimization information between devices to ensure that other network devices can adjust their parameters accordingly. That is, changes in the self-organizing network can affect a number of different types of devices. For example, changes in the eNBs in the RAN impact settings on the MMEs and SGWs, such when there are changes in tracking area (TA) lists. The self organizing network propagates changes in an organized fashion to provide coordinated changes. If changes are not properly coordinated, then the stability of the network can be compromised. For example, if changes are not properly propagated amongst the groups of network devices then failures or overloads can occur at devices that were improperly updated or configured. A challenge in the self-organizing network is the management of the entities and to ensure that the proper changes are being instituted in a timely fashion so as to not compromise the stability of the network.

The self-organizing network can include both centralized communication and distributed communication. Centralized communication includes communication that uses a central node to pass communications to correct network devices, while distributed communication includes communications from any one network device to any other network devices. In some embodiments, communication between groups of devices (e.g., between the MME pool and the eNB cluster) is done through a management server such as an O&M server. This management server can coordinate and manage the inter-group communications to ensure that communications are sent to the appropriate network devices. Network devices that exchange group-specific information can use a distributed protocol without burdening a management server such as an O&M server. Some network devices in certain groups, such as SGWs, may not need to communicate so for these network devices a distributed protocol is not needed.

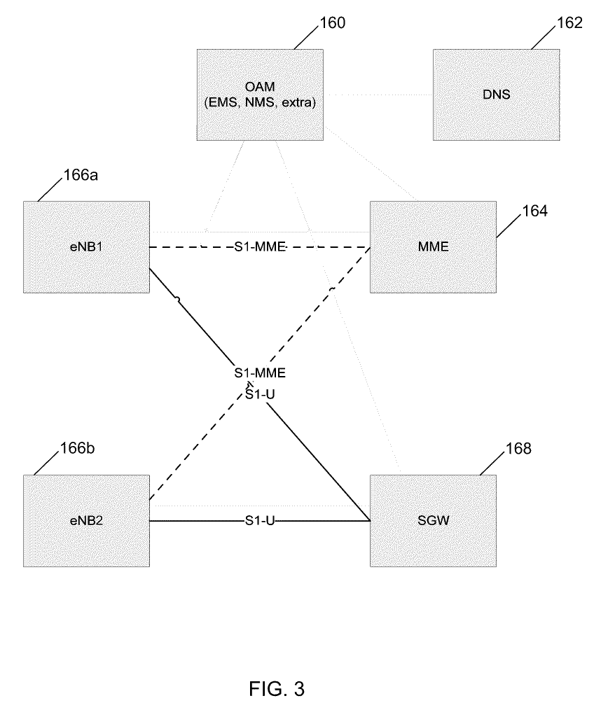

FIG. 3 illustrates a network view of an evolved packet core SON in accordance with some embodiments. FIG. 3 includes a management server 160, a domain name server (DNS) 162, a mobility management entity (MME) 164, eNodeBs 166a and 166b, and serving gateway (SGW) 168. The management server 160 can be an operations and management server (O&M), a element management server (EMS), and/or a network management system (NMS). The network management system (NMS)/element management system (EMS) can provide management of the operation, administration, maintenance, and provisioning of networked system. Operation deals with keeping the network (and the services that the network provides) up and running smoothly, and includes monitoring to detect problems and minimize disruptions on the network. Administration deals with keeping track of resources in the network and how they are assigned. Maintenance is concerned with performing repairs and upgrades—for example, when equipment must be replaced, when a router needs a patch for an operating system image, when a new switch is added to a network.

Provisioning is concerned with configuring resources in the network to support a given service. For example, this might include setting up the network so that a new customer can receive service. Functions that are performed as part of network management include network planning, frequency allocation, predetermined traffic routing to support load balancing, cryptographic key distribution authorization, configuration management, fault management, security management, performance management, bandwidth management, and accounting management. It can also include controlling, planning, allocating, deploying, coordinating, and monitoring the resources of a network. An element management system (EMS) consists of systems and applications that manage network elements (NE) on the network element management layer (NEL) of the Telecommunication Management Network model.

As shown in FIG. 3, the management server 160 communicates with DNS 162, MME 164, eNBs 166a and 166b, and SGW 168. The management server 160 can provide centralized communication among these disparate network elements. The management server 160 can collect statistical information from the network devices in the self organizing through a series of data pulls from the network devices. The network devices are set to monitor themselves and other information in order to collect information that can be pulled by the management server 160. Management server 160 then uses this statistical data to calculate metrics and determine how to configure the network. The metrics can include capacity, resources available, number of active sessions, coverage, mobility, etc. From these metrics, policies or a logic can be used in order to manage and optimize the network with little to no human involvement. Once an optimization or other change is identified at the management server 160, instructions carried in control signals are pushed to the various network devices. The network devices can communicate between each other using various interfaces. For example, MME 164 can communicate with eNB 166a using a S1-MME interface and SGW 168 can communicate with eNB 166 using a S1-U interface. Si is a standardized interface between eNB and the Evolved Packet Core (EPC). S1-MME is used for exchanging signaling messages between the eNB and the MME and S1-U is used for transporting user datagrams between the eNB and the Serving Gateway (S-GW).

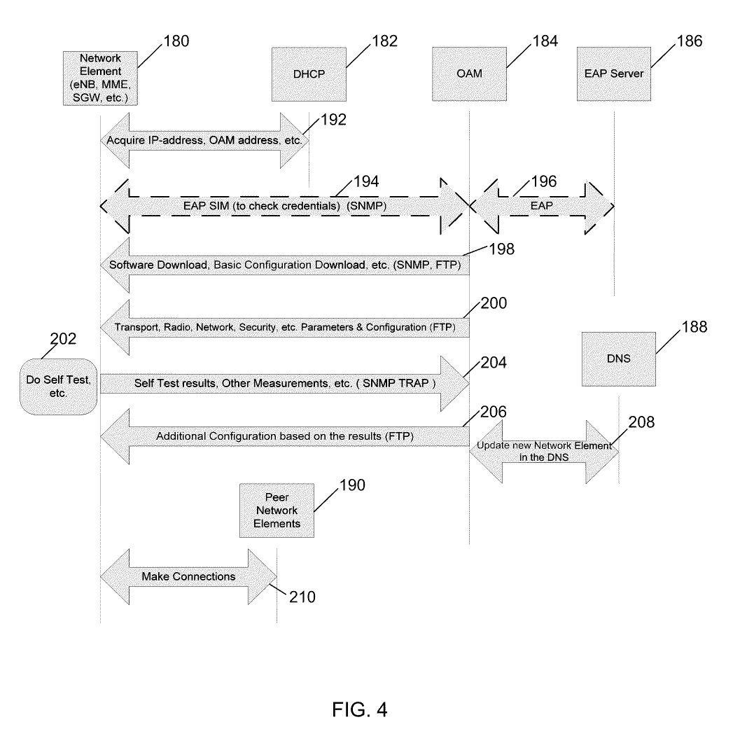

FIG. 4 illustrates self configuration messaging in a self-organizing network in accordance with some embodiments. FIG. 4 includes a network element or network device 180, a DHCP server 182, a management server or OAM server 184, an extensible authentication protocol (EAP) server 186, a DNS server 188, and peer network elements 190. The network devices that are part of the self-organizing network are configured to engage in self configuration when attached to or booting up in a self-organizing network. In order to configure itself, the network device 180 communicates in 192 with the DHCP server 182 to acquire an IP address, the OAM address, and other address and location information. The network device 180 communicates with OAM server 184 using an extensible authentication protocol (EAP) in 194.

EAP is an authentication framework providing for the transport and usage of keying material and parameters generated by EAP methods. EAP methods include some common functions and methods for authentication negotiation. EAP defines messages formats and each protocol that uses EAP defines a way to encapsulate EAP messages within that protocol's messages. Some EAP methods include EAP-MD5, EAP-OTP, EAP-GTC, EAP-TLS, EAP-IKEv2, EAP-SIM, and EAP-AKA. Extensible Authentication Protocol Method for GSM Subscriber Identity Module (EAP-SIM) is an EAP mechanism for authentication and session key distribution using the Global System for Mobile Communications (GSM) Subscriber Identity Module (SIM). GSM cellular networks use a subscriber identity module (SIM) card to carry out user authentication. EAP-SIM uses a SIM authentication algorithm between the client and a Authentication, Authorization and Accounting (AAA) server providing mutual authentication between the client and the network.

The messaging in 194 provides a mechanism for checking credentials of a user equipment or network device. Even though EAP-SIM is illustrated, other authentication mechanisms can be used to check credentials. The EAP-based authentication can be in conjunction with Simple Network Management Protocol (SNMP). SNMP is a UDP-based network protocol that can be used in network management systems to monitor network-attached devices for conditions that warrant administrative attention. SNMP includes a set of standards for network management, including an application layer protocol, a database schema, and a set of data objects. SNMP carries management data in the form of variables in the self-organized network, where the variables are extensive and carry monitoring and statistic information from the network devices. These variables can then be queried and sometimes set by the management server 184. In a self-organizing network, SNMP can be used by the management server 184 to monitor the network devices within the self-organizing network and to obtain monitor information to allow management decisions to be implemented. The management server 184 includes a database where the information obtained via SNMP can be stored.

The management server 184 can also facilitate the authentication of a network device on the self-organizing network. This can allow the device to be trusted and for the device to send information that can be trusted. The authentication process can include the management server 184 communicating in 196 with EAP server 186. The EAP server 186, in some embodiments, can be implemented on an AAA server or through a similar functionality. In messaging 198, the management server 184 can send software downloads, configuration downloads, or other relevant information to allow the network device to configure itself The software downloads can include updates, upgrades, new releases, software used in the self-organizing network, and configuration files. The configuration files can include policies or other instructions on how to perform optimizations, what information to monitor, how to contact peer nodes, for example. The messaging 198 can be sent using SNMP or file transfer protocol (FTP), for example.

Parameter and configuration information for specific tasks and aspects of operation can also be provided from the management server 184 to the network device 180 in the process of self-configuration. In messaging 200, transport parameters and configuration information, radio parameters and configuration information, network parameters and configuration information, security parameters and configuration information, and device parameters and configuration information can be sent to or exchanged with network device 180. The network device 180 can use the parameters, configuration information, and software to setup for running on the network.

The network device 180 in 202 performs a self test to determine if everything is working properly. The self test can involve running test software that was received by the management server or by monitoring components on the network device in response to specified inputs. The self test results as well as other monitoring measurements can be sent to the management server 184 in messaging 204. The messaging 204 can be implemented using SNMP TRAP, which is a type of packet data unit used to report an alert or other asynchronous event about a managed system. The results in messaging 204 can be analyzed by OAM server 184 to determine how the network device will function in the SON. The analysis can determine a profile and/or initial operating parameters for the network device such as loading and assignment of tasks within the network, for example. In messaging 206, additional configuration information is sent from the management server 184 to the network device 180. This additional configuration information can be based on the analysis of the results of self test and/or other measurements and statistical information obtained from the network device. The messaging 206 can use FTP to deliver the configuration files.

When the network device is configured into the self-organizing network, the central managing server 184 communicates in 208 with DNS 188 to update the network device 180 into the DNS. When network device 180 is included in the DNS then it will be available for lookup and use in the network. Once the network device 180 is finished with configuring itself for the self-organizing network, the network device can begin peer discovery and make connections with other network devices 190. This can involve advertising the network device's profile to other network devices in the SON. The network device 180 can make connections with other network device 190 in messaging 210.

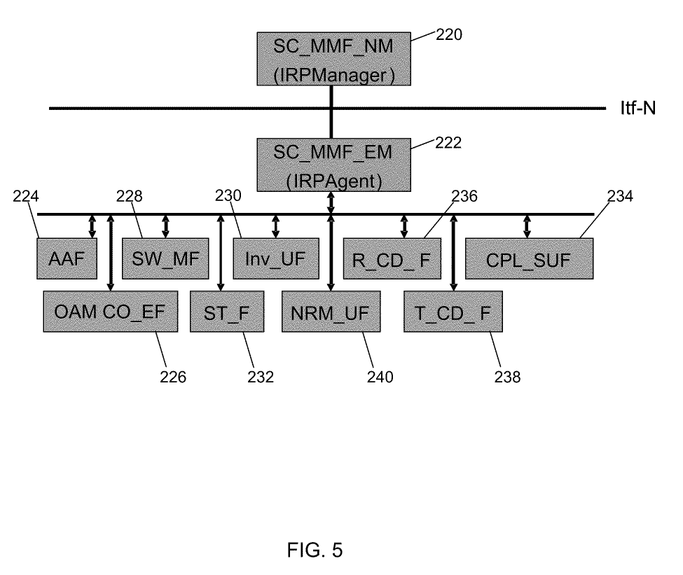

FIG. 5 illustrates self-organizing network functions in accordance with certain embodiments. The SON functions can include a self-configuration monitoring and management function (SC_MMF_NM) 220 that serves as a network manager (IRPmanager), a self-configuration monitoring and management function (SC_MMF_EM) 222 that servers as an agent for a centralized manager (IRPagent), an address allocation function (AAF) 224 that serves to track and in some cases distribute addressing information, an OAM connectivity establishment function (OAM CO_EF) 226 that serves to provide a connection to the management server, a software management function (SW_MF) 228 that serves to manage the software on a devices and can provide information about the software residing on a device, an inventory update function (Inv_UF) 230 that serves to relay information about resources availability and what is available on a device, a self-test function (ST_F) 232 that serves to monitor the network device, conduct tests on the device, and report back to the manager function 220. The SON further includes a call processing link (CPL) set up function (CPL_SUF) 234 that serves to setup data paths for call processing, a radio network configuration data function (R_CD_F) 236 that implements configuration information for the RAN, a transport network configuration data function (T_CD_F) 238 that implements configuration information for the network, a NRM IRP update function (NRM_UP) 240 for updating the IRPmanager 220, and a radio network and transport network configuration data preparation function (not shown) that serves to facilitate communication.

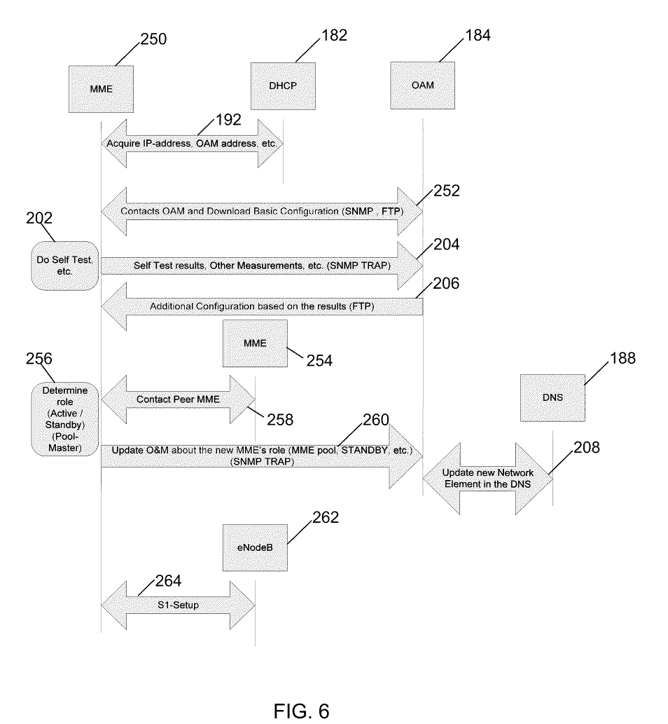

FIG. 6 illustrates a message flow for the auto-configuration of a MME in accordance with some embodiments. FIG. 6 includes an MME 250, a DHCP server 182, an operations and management server (OAM) 184, a peer MME 254, a DNS 188, and an eNodeB 262. In messaging 192, the MME communicates in 192 with the DHCP server 182 to acquire an IP address, the management server address, and other address and location information. The MME 250 can initiate communication 252 with the management server 184 to download software and/or configuration information using SNMP or FTP, for example. The software and configuration information is used by the MME 250 to setup the device for working within the context of the self-organizing network. A self-test 202 determines the capabilities of the MME and communicates this information in messaging 204 to the management server 184. The self-test 202 can also monitor certain aspects of the MME 250 to provide other measurements to the management server 184. The management server 184 analyzes these measurements and test data to determine the capabilities of the MME in order to determine the profile and how the MME fits into the self-organizing network.

The management server 184 sends additional configuration information 206 based on the self-test results that is used by the MME to setup for operation in the self-organizing network. In 256, the MME 250 determines its role among its peers. The role can include an active role, a standby role, and a master of the pool of MMEs, for example. The active and standby roles can be used for failure protection and load balancing. MME 250 communicates in 258 with other peer MMEs 254 to perform neighbor and neighborhood discovery as well as to determine the role of peer group MMEs and to obtain information regarding the profiles and roles of peer MMEs. The determination of the role of MME 250 can be influenced by the roles of peer MMEs 254. In messaging 260, MME 250 updates the management server 184 about the MME's profile and role such as the state of the MME, the grouping, and other parameters. The update can be sent using SNMP TRAP. The management server 184 updates the MME 250 in the DNS using messaging 208. MME 250 also communicates with eNodeBs 262 to perform a S1 interface setup 264.

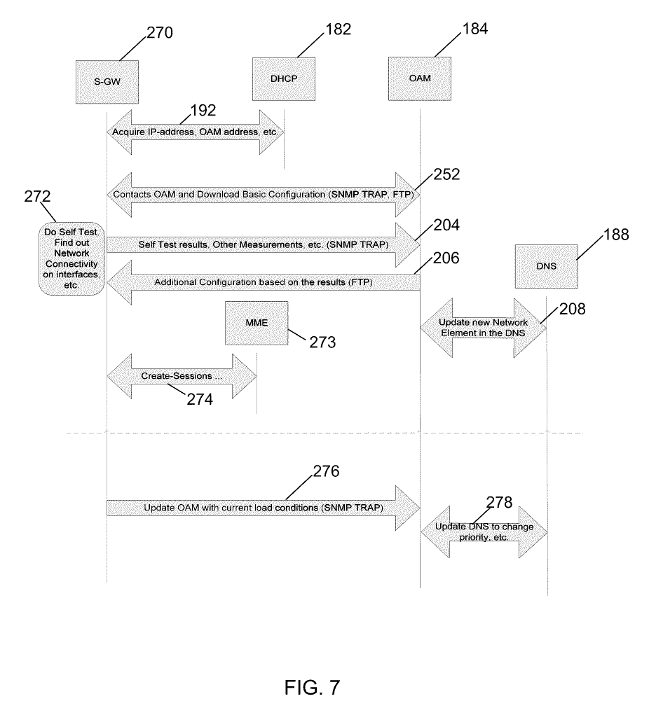

FIG. 7 illustrates a message flow for the auto-configuration of a SGW in accordance with some embodiments. FIG. 7 includes an SGW 270, a DHCP server 182, an operations and management server (OAM) 184, DNS 188, and MME 273. In messaging 192, the SGW 270 communicates in 192 with the DHCP server 182 to acquire an IP address, the OAM address, and other address and location information. The SGW 270 can initiate communication 252 with the management server 184 to download software and/or configuration information. The software and configuration information is used by the SGW 270 to setup for working within the context of the self-organizing network. A self-test 272 can be used to determine the capabilities of the SGW. These capabilities are communicated in messaging 204 to the management server 184. The self-test 272 can also monitor certain aspects of the SGW 270 to provide other measurements to the management server 184. The management server 184 analyzes these measurements and test data to determine the capabilities of the SGW in order to determine the profile and how the SGW fits into the self-organizing network.

Additional configuration information 206 based on the self-test results is sent by the management server 184 to setup the SGW 270. The SGW uses this configuration information to setup for operation in the self-organizing network. In messaging 208, the management server 184 updates the DNS 188 to include the new SGW. After being configured, the SGW 270 creates sessions 274 with MMEs 273 in the self-organizing network. The SGWs can also initiate peer discovery and other information gathering from other network elements. In messaging 276, the SGW 270 can update the management server using an management message. The management message can include information such as load conditions and other operating information. The management message can be an SNMP TRAP message. The management server 184 can also initiate pulls of monitoring and statistic information from the network devices including the SGW 270. The management server 184 also updates 278 the DNS 188 when changes occur in SGW 270 such as a change of priority.

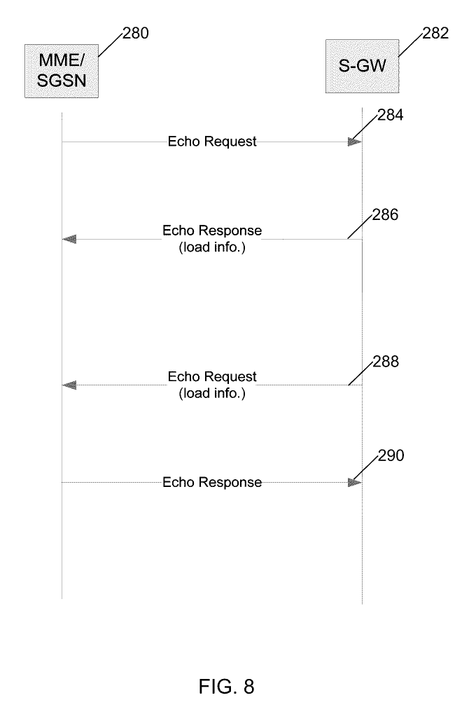

FIG. 8 illustrates network device reporting of information in accordance with certain embodiments. The network device can report information, such as load information, network device health, error logs, billing information, policy information, or any other applicable information. FIG. 8 includes a MME/SGSN 280 and a SGW 282. The MME/SGSN 280 sends an echo request 284 to SGW 282. In response to the echo request, the SGW 282 sends a echo response message 286 which can include a private extension that is used to carry information, such as load information. The SGW 282 can also request information from the network, for example, by sending an echo request message 288. The echo request messaging can include a private extension that requests particular information. The MME/SGSN 280 responds with an echo response 290 that includes the information requested.

The information exchanged with a gateway can be used for gateway selection, implementing redundancy operations, and for maintaining quality of service (QoS). For example, in implementing redundancy operations, a first SGW can send a second SGW information about the sessions that the first SGW is handling, so that the second SGW can resume operations of the first SGW in the event of a failure or other situation.

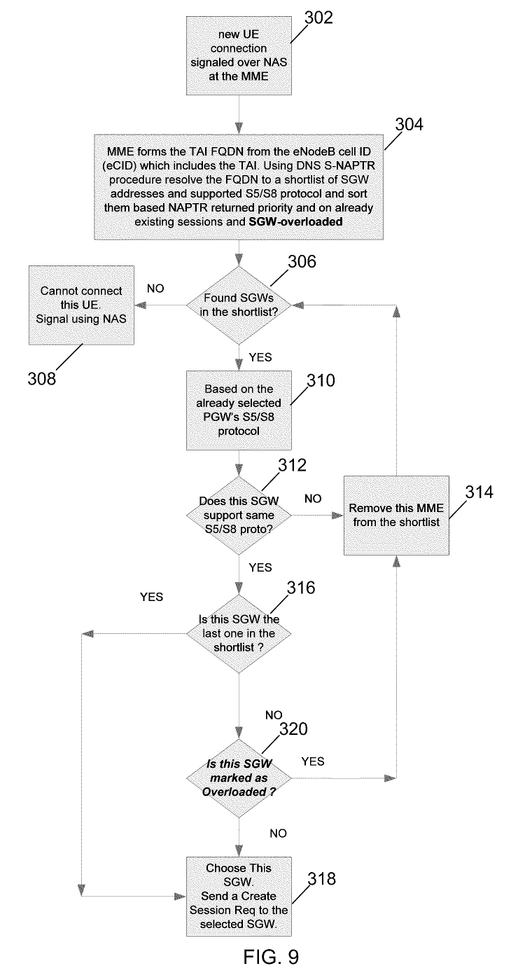

FIG. 9 illustrates network device selection at a MME using a selection logic in accordance with some embodiments. The selection logic can be stored as executable instructions in a computer readable medium that is accessible by a processor on a chassis implementing the MME. In 302, a new UE connection is signaled over the non access stratum (NAS) protocol to the MME. In 304, the MME forms a tracking area identity fully qualified domain name (TAI FQDN) from the eNodeB cell ID (eCID) including the tracking area identity. Using DNS straightforward-name authority pointer (S-NAPTR) procedure, the MME resolves the FQDN to a shortlist of SGW addresses and supported S5/S8 protocols. These are sorted based on a combination of NAPTR returned priority, on already existing sessions, and overload weighting. The overload weighting can be SGW or PGW loading conditions as represented in the data structure.

In 306, the MME finds SGWs in the shortlist created in 304. If no SGWs are found in the shortlist in 306, this UE cannot connect using NAS, and the MME signals the UE that a session cannot be established in 308. If a SGW can be found in 306, a PGW is selected in 310 based on the S5/S8 protocol. In 312, the MME checks whether the SGW supports the same S5/S8 protocol as the PGW. If not in 314, the SGW is removed from the MME shortlist and the process starts over with a modified shortlist in 306. If the SGW does support the same protocol in 312, then the MME checks if the SGW is the last one in the shortlist in 316. If the SGW is the last one in the shortlist in 316, this SGW is chosen in 318 and a create session request is sent to the selected SGW.

If the SGW is not the last one in the shortlist 316, then the MME checks whether the SGW is marked as overloaded in 320. If the SGW is marked as overloaded in 320, this entry can be checked for when the SGW was marked and the number of times the SGW has been selected from the shortlist. If the time meets a threshold or a threshold number of tries have been passed up, this SGW is chosen and the new result is written into the data structure. For example, if the attempt is successful then the SGW is unmarked. If the attempt is unsuccessful, then the entry is rewritten as being unsuccessful resetting the time and number of attempts. If the threshold is not met in 320 and the SGW is marked as overloaded, then this is removed from the shortlist in 314. The PGW can go through the same overloaded check in the selection logic to determine the PGW selected.

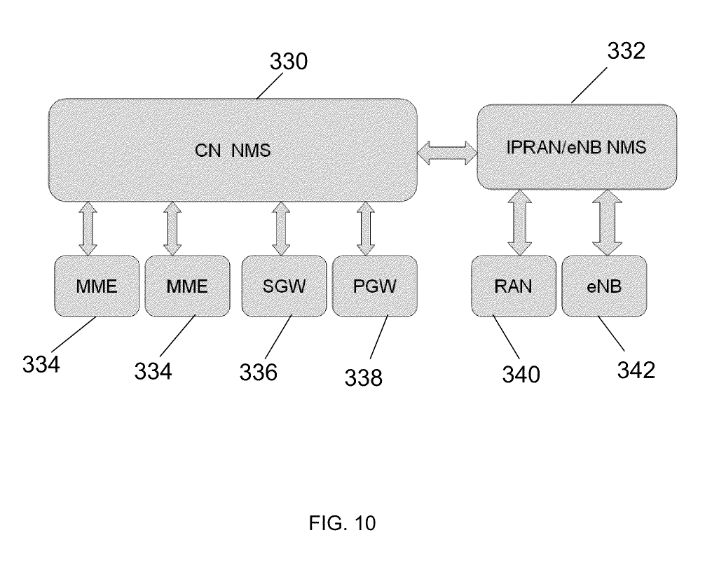

FIG. 10 illustrates another embodiment of a self-organizing network in accordance with some embodiments. FIG. 10 includes a core network (CN) network management system (NMS) 330, an internet protocol radio access network (IPRAN)/eNB network management system (NMS) 332, MMEs 334, SGW 336, packet data network gateway (PGW) 338, RAN 340, and eNB 342. CN NMS 330 manages the MME 334, SGW 336, PGW 338 and other network devices that are in the core network. The management server 330 gets the performance statistics of the network devices and uses thresholds to generate notifications to the service provider's operations support systems (OSS). These notifications can be logged to later analyze failures and provide other information to the service provider. These same notification can also trigger actions to the network devices on the RAN side using the IPRAN NMS 332, in some embodiments. In this trigger, overloading conditions and other information can be sent to the RAN NMS using protocols like SNMP or 3GPP XML interface. In some embodiments, the CNN MS 330 management server and the IPRAN NMS 332 management server can be provided on the same server. In other embodiments, the core network management server 330 and the RAN management server 332 are provided on different servers and communicate between one another to coordinate management actions. The network management server can be implemented on a Cisco blade server.

The core network management server 330 can also manage the orderly upgrade process to the network device groups such as the existing MME and SGW pools. Additionally, the core network management server 330 can facilitate software load/downtime for repair and upgrades by making the RAN network management server 332 aware of the existing pool conditions. This can allow the RAN network management server 332 to dynamically modify the RAN communication with the core network to facilitate core network operations. The dynamic modifications can include re-assigning RAN capacity among the core network devices. The CN NMS 330 can also act as a controller for the health of network devices such as the MME and SGW pools. Depending on the SON, it can be centralized or distributed, or a hybrid combination. In a hybrid combination, some communications can be centralized (e.g., using a O&M server) while others are distributed.

The functions for providing a self organizing network (SON) can be implemented on a network device, in some embodiments, by modifying the software of a chassis to support the functions. For example, the Linux based operating system running on the chassis supports a command line interface and the software running on the chassis can be modified to allow for decommissioning the gateway. Further, the software can be modified to change resources and send out message to change resources on other network devices.

The self-organizing network can use a number of different communication protocols to facilitate the implementation of the functionalities. These protocols can be used in various combinations and in place of one another as described above. For example, dynamic host configuration protocol (DHCP) can be used for auto address configuration, transfer protocols such as FTP, SFTP, and TFTP can be used for software downloads and obtaining statistics from network devices. Secure shell (SSH), command line interface (CLI), and common object request broker architecture (CORBA) can be used for configuration. CORBA can also be used for taking measurements on network devices and auto expansion at network devices (e.g., request more address pools). SNMP can used for configuration, software downloads, and alarms.

The network device or gateway described above can be implement on a chassis with multiple and different integrated functionalities. In some embodiments, a mobility management entity (MME), a serving gateway (SGW), a PDN gateway (P-GW), an access gateway, a packet data serving node (PDSN), a foreign agent (FA), or home agent (HA) can be implemented on a chassis. Other types of functionalities can also be implemented on a chassis in other embodiments are a Gateway General packet radio service Serving Node (GGSN), a serving GPRS support node (SGSN), a packet data inter-working function (PDIF), an access service network gateway (ASNGW), a base station, a access network, a User Plane Entity (UPE), an IP Gateway, an access gateway, a session initiation protocol (SIP) server, a proxy-call session control function (P-CSCF), and an interrogating-call session control function (I-CSCF), a serving gateway (SGW), and a packet data network gateway (PDN GW). In certain embodiments, one or more of the above-mentioned other types of functionalities are integrated together or provided by the same functionality. For example, an access network can be integrated with a PDSN. A chassis can include a PDSN, a FA, a HA, a GGSN, a PDIF, an ASNGW, a UPE, an IP Gateway, an access gateway, or any other applicable access interface device. In certain embodiments, a chassis is provided by Starent Networks of Tewksbury, Mass. in a ST16 or a ST40 multimedia platform or a Cisco Systems ASR5000 gateway platform.

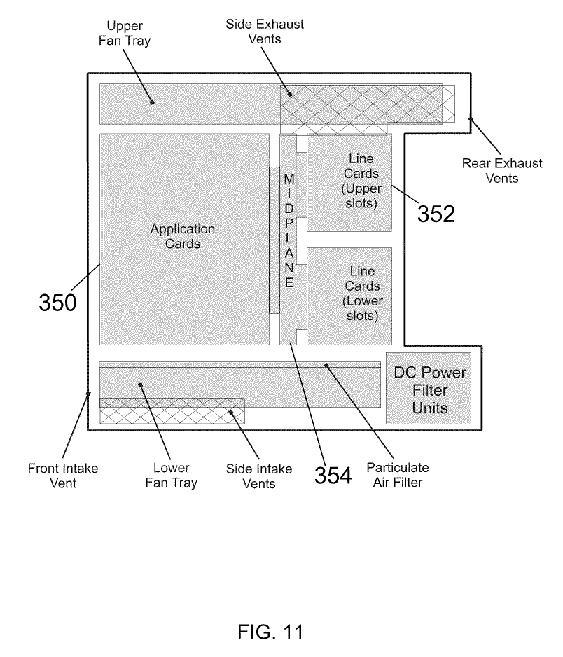

The features of a chassis that implements a gateway, in accordance with some embodiments, are further described below. FIG. 11 illustrates positioning of cards in the chassis in accordance with some embodiments. The chassis includes slots for loading application cards 350 and line cards 352. A midplane 354 can be used in the chassis to provide intra-chassis communications, power connections, and transport paths between the various installed cards. The midplane 354 can include buses such as a switch fabric, a control bus, a system management bus, a redundancy bus, and a time division multiplex (TDM) bus. The switch fabric is an IP-based transport path for user data throughout the chassis implemented by establishing inter-card communications between application cards and line cards. The control bus interconnects the control and management processors within the chassis. The chassis management bus provides management of system functions such as supplying power, monitoring temperatures, board status, data path errors, card resets, and other failover features. The redundancy bus provides transportation of user data and redundancy links in the event of hardware failures. The TDM bus provides support for voice services on the system.

The chassis supports at least four types of application cards: a switch processor card, a system management card, a packet service card, and a packet accelerator card. The switch processor card serves as a controller of the chassis and is responsible for such things as initializing the chassis and loading software configurations onto other cards in the chassis. The packet accelerator card provides packet processing and forwarding capabilities. Each packet accelerator card is capable of supporting multiple contexts. Hardware engines can be deployed with the card to support parallel distributed processing for compression, classification traffic scheduling, forwarding, packet filtering, and statistics compilations. The system management card is a system control and management card for managing and controlling other cards in the gateway device. The packet services card is a high-speed processing card that provides multi-threaded point-to-point, packet data processing, and context processing capabilities, among other things.

The packet accelerator card performs packet-processing operations through the use of control processors and a network processing unit. The network processing unit determines packet processing requirements; receives and transmits user data frames to/from various physical interfaces; makes IP forwarding decisions; implements packet filtering, flow insertion, deletion, and modification; performs traffic management and traffic engineering; modifies/adds/strips packet headers; and manages line card ports and internal packet transportation. The control processors, also located on the packet accelerator card, provide packet-based user service processing. The line cards when loaded in the chassis provide input/output connectivity and can also provide redundancy connections as well.

The operating system software can be based on a Linux software kernel and run specific applications in the chassis such as monitoring tasks and providing protocol stacks. The software allows chassis resources to be allocated separately for control and data paths. For example, certain packet accelerator cards can be dedicated to performing routing or security control functions, while other packet accelerator cards are dedicated to processing user session traffic. As network requirements change, hardware resources can be dynamically deployed to meet the requirements in some embodiments. The system can be virtualized to support multiple logical instances of services, such as technology functions (e.g., a PDN GW, SGW, PDSN, ASNGW, PDIF, HA, GGSN, or IPSG).

The chassis' software can be divided into a series of tasks that perform specific functions. These tasks communicate with each other as needed to share control and data information throughout the chassis. A task is a software process that performs a specific function related to system control or session processing. Three types of tasks operate within the chassis in some embodiments: critical tasks, controller tasks, and manager tasks. The critical tasks control functions that relate to the chassis' ability to process calls such as chassis initialization, error detection, and recovery tasks. The controller tasks mask the distributed nature of the software from the user and perform tasks such as monitor the state of subordinate manager(s), provide for intra-manager communication within the same subsystem, and enable inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem can include critical tasks, controller tasks, and manager tasks. Some of the subsystems that can run on a chassis include a system initiation task subsystem, a high availability task subsystem, a recovery control task subsystem, a shared configuration task subsystem, a resource management subsystem, a virtual private network subsystem, a network processing unit subsystem, a card/slot/port subsystem, and a session subsystem.

The system initiation task subsystem is responsible for starting a set of initial tasks at system startup and providing individual tasks as needed. The high availability task subsystem works in conjunction with the recovery control task subsystem to maintain the operational state of the chassis by monitoring the various software and hardware components of the chassis. Recovery control task subsystem is responsible for executing a recovery action for failures that occur in the chassis and receives recovery actions from the high availability task subsystem. Shared configuration task subsystem provides the chassis with an ability to set, retrieve, and receive notification of chassis configuration parameter changes and is responsible for storing configuration data for the applications running within the chassis. Resource management subsystem is responsible for assigning resources (e.g., processor and memory capabilities) to tasks and for monitoring the task's use of the resources.

Virtual private network (VPN) subsystem manages the administrative and operational aspects of VPN-related entities in the chassis, which include creating separate VPN contexts, starting IP services within a VPN context, managing IP pools and subscriber IP addresses, and distributing the IP flow information within a VPN context. In some embodiments, within the chassis, IP operations are done within specific VPN contexts. The network processing unit subsystem is responsible for many of the functions listed above for the network processing unit. The card/slot/port subsystem is responsible for coordinating the events that occur relating to card activity such as discovery and configuration of ports on newly inserted cards and determining how line cards map to application cards. The session subsystem is responsible for processing and monitoring a mobile subscriber's data flows in some embodiments. Session processing tasks for mobile data communications include: A10/A11 termination for CDMA networks, GSM tunneling protocol termination for GPRS and/or UMTS networks, asynchronous PPP processing, packet filtering, packet scheduling, Difserv codepoint marking, statistics gathering, IP forwarding, and AAA services, for example. Responsibility for each of these items can be distributed across subordinate tasks (called managers) to provide for more efficient processing and greater redundancy. A separate session controller task serves as an integrated control node to regulate and monitor the managers and to communicate with the other active subsystem. The session subsystem also manages specialized user data processing such as payload transformation, filtering, statistics collection, policing, and scheduling.

In some embodiments, the software needed for implementing a process or a database includes a high level procedural or an object-orientated language such as C, C++, C#, Java, or Perl. The software may also be implemented in assembly language if desired. Packet processing implemented in a chassis can include any processing determined by the context. For example, packet processing may involve high-level data link control (HDLC) framing, header compression, and/or encryption. In certain embodiments, the software is stored on a storage medium or device such as read-only memory (ROM), programmable-read-only memory (PROM), electrically erasable programmable-read-only memory (EEPROM), flash memory, or a magnetic disk that is readable by a general or special purpose-processing unit to perform the processes described in this document.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

We claim:

1. A method comprising:
initiating at a network device, upon introduction to a self-organizing network, communication to acquire addressing information of the network device and a managing server for the self-organizing network, and to obtain configuration information from the management server to initialize the network device on the self-organizing network;
performing a self-test at the network device to determine how to configure the network device on the self-organizing network and sending the self-test results to the management server to obtain additional configuration information that is based on the results of the self-test;
announcing information from the network device to initiate exchange of information with other network devices and to establish connections to provide service to user equipment sessions on the self-organizing network;
monitoring resources and user equipment session information on the network device and logging this information for use by the management server; and
adjusting parameters relating to a plurality of user equipment sessions and determining whether to accept and how to modify existing user equipment sessions based on instructions received from the management server.

2. The method of claim 1, wherein the network device includes a mobility management entity (MME).

3. The method of claim 2, further comprising:
communicating with peer MMEs in an MME pool to determine tracking area list overlap and exchange MME pool specific information; and
communicating with serving gateways (SGW) to determine the serving gateways capabilities.

4. The method of claim 2, further comprising:
communicating with the management server MME load information; and
receiving instructions at the MME to load balance user equipment sessions with another MME in the self-organizing network.

5. The method of claim 1, wherein the network device includes a serving gateway (SGW).

6. The method of claim 5, further comprising receiving a profile type from the management server based on a SGW's capabilities, the profile type describing the capabilities of the SGW including protocols the SGW communicates on in the self-organizing network.

7. The method of claim 6, further comprising providing the profile type of the SGW to a mobility management entity (MME) in the self-organizing network.

8. The method of claim 6, further comprising sending the management server load conditions at the SGW to trigger the management server to change priority information regarding the SGW.

9. The method of claim 1, wherein simple network management protocol (SNMP) is used to communicate data in a structured form to enable management and configuration of the network device from the management server.

10. A network device comprising:
an interface configured to communicate with a server to obtain an IP address for the network device and to obtain an IP address for a management server;
an interface configured to communicate with the management server to obtain software and configuration information to initialize the network device on a self-organizing network;
an interface configured to communicate with other network devices in the self-organizing network to exchange information and establish connections to provide service to user equipment sessions on the self-organizing network;
a self-test function configured to obtain operation and capability information regarding the network device;
a self-configuration function that configures the network device for operation in the self-organizing network using the software and configuration information received from the management server, and the network device modifies its operation based upon instructions received from the management server; and
a self-configuration monitoring function configured to monitor resources and user equipment session information on the network device and logging this information for use by the management server.

11. The network device of claim 10, wherein the network device provides mobility management entity (MME) functionality.

12. The network device of claim 11, wherein the interface is used to communicate with peer MMEs in an MME pool to determine tracking area list overlap and exchange MME pool specific information and to communicate with serving gateways (SGW) to determine the serving gateways capabilities.

13. The network device of claim 11, wherein the interface is used to communicate MME load information with the management server and to receive instructions for the MME to load balance user equipment sessions with another MME in the self-organizing network.

14. The network device of claim 10, wherein the network device provides serving gateway (SGW) functionality.

15. The network device of claim 15, wherein the SGW receives a profile type from the management server based on a SGW's capabilities, and the profile type describes the capabilities of the SGW including protocols the SGW communicates in on the self-organizing network.

16. The network device of claim 15, wherein the SGW provides the profile type to a mobility management entity (MME) in the self-organizing network.

17. The network device of claim 15, wherein the interface is used to send the management server load conditions at the SGW to trigger the management server to change priority information regarding the SGW.

18. The network device of claim 15, wherein simple network management protocol (SNMP) is used to communicate data from the interface in a structured form to enable management and configuration of the network device from the management server.

19. A method comprising:
acquiring an IP address and a management server address from a dynamic host configuration protocol (DHCP) server;
communicating from a network device with a management server to download software and configuration information to setup the network device;
performing a self test of the network device to obtain result and measurement information regarding capabilities of the network device that are used to determine how to configure the network device for operation in the self organizing network;
communicating with other network devices to determine the other network devices capabilities and providing the other network devices information regarding the network device;
monitoring resources and other information regarding the network device for communication to the management server;
receiving instructions from the management server on the network device and modifying the configuration of the network device in accordance with the instructions.

20. The method of claim 19, wherein the network device is at least one of a mobility management entity (MME), a serving gateway (SGW), and an eNodeB.
